(19) United States
(12) Patent Application Publication
(10) Pub. No.: US 2006/0111270 A1
(43) Pub. Date: May 25, 2006

(54) Ketocampholenic acid derivatives and their use in fragrance applications

(76) Inventor: Sergey Selifonov, Plymouth, MN (US)

Correspondence Address: FISH & RICHARDSON P.C., PO BOX 1022, MINNEAPOLIS, MN, 55440-1022, US

(21) Appl. No.: 10/523,060

(22) PCT Filed: Jul. 24, 2003
(86) PCT No.: PCT/US03/23130

§ 371 Date: Oct. 18, 2005

Related U.S. Application Data
(60) Provisional application No. 60/400,475, filed on Aug. 2, 2002.

(51) Int. Cl. A61Q 13/00

(52) U.S. Cl. 512/10

(57) ABSTRACT

Ketocampholenic acid derivatives, their use, and methods of preparing these derivatives are described. In one aspect, novel derivatives of 2-oxo-4,5,5-trimethylcyclopent-3-enylacetic acid (herein further referred as ketocampholenic acid or KCA), which is a natural product that may be prepared by microbial biological oxidation of camphor or of a suitable precursor, are described. Novel derivative compounds may be prepared according to the methods described in the present invention. Such derivative olfactory properties that make them useful in fragrance and flavor applications.

### CROSS-REFERENCE TO RELATED APPLICATIONS

This application claims priority to U.S. provisional patent application No. 60/400,475 filed Aug. 2, 2002, entitled “Ketocampholenic acid derivatives and their use” by Selifonov, S. A., which is hereby incorporated by reference in its entirety.

### BACKGROUND

A number of campholenic and campholanic acid derivatives are known. Some, such as lower alkyl esters of alpha-campholenic acid and alpha-campholanic acid, have attractive scent and flavor properties.

### SUMMARY

In one aspect, novel derivatives of 2-oxo-4,5,5-trimethylcyclopent-3-enylacetic acid (herein further referred as ketocampholenic acid or KCA), which is a natural product that may be prepared by microbial biological oxidation of camphor or of a suitable precursor, are described. Novel derivative compounds may be prepared according to the methods described in the present invention. Such derivative compounds have been found to possess a diverse range of attractive olfactory properties that make them useful in fragrance and flavor applications.

In general, the methods for preparing these derivatives involve the use of biocatalysis wherein KCA is prepared biologically by oxidizing camphor or a suitable camphor precursor. Esterification of the KCA with alcohols affords KCA esters that have attractive organoleptic properties. The KCA esters are chiral compounds of general formula (1).

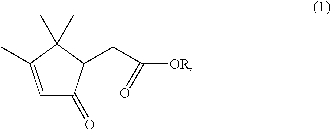

wherein R is lower alkyl or alkenyl, normal or branched or cyclic, having 1 to 10 carbon atoms.

The enantiomeric composition of such compounds depends on the enantiomeric composition of camphor or other suitable camphor precursor used for the biooxidation step, as compounds of formula 1 can be prepared from either enantiomer of camphor or racemic camphor. Enantiomeric composition of compounds (1) and any derivatives that are prepared by use of additional chemical reactions can be influenced by racemization reaction which occurs readily when KCA or esters thereof are contacted with an acid or with a base.

Hydrogenation of the double bond of the cyclopentene ring of KCA or ester of formula 1 affords ketocampholanic esters of formula (2) also having attractive organoleptic properties:

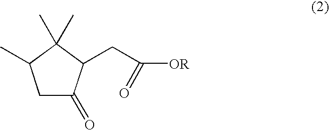

Reduction of the carbonyl group, with or without reduction of the double bond, affords preparation of hydroxycampholenic and hydroxycamphanic acid esters of formula 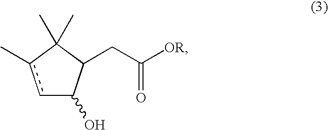
wherein the dashed bond is a single or double bond, and wherein the wiggled bond is in cis- or trans-configuration in respect to the side chain bearing the carboxyl group.

Reduction of the carbonyl group of KCA, with or without reduction of the double bond, also affords preparation of lactones of formula (4) that have attractive scent and taste properties.

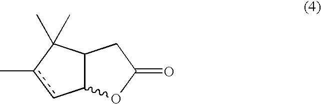

Preparation of compounds of formulae (3) and (4) allows for synthesis of cyclopentene or cyclopentadiene compounds of formula (5):

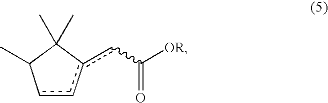

wherein any one of the three dashed bonds is double and the other two are single, and of formula (6):

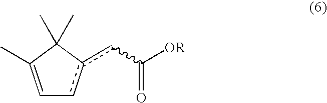

wherein anyone of the three dashed bonds is double and the other is single.

Various isomers of compounds (5) and (6) have potent pleasant characteristic odors that make them useful for flavor and fragrance applications.

In another aspect, the invention features a compound having the formula (7):

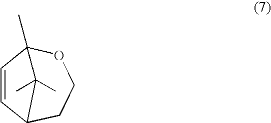

In general, the compounds described herein have attractive odor characteristics in a broad range of distinctive and original scents that can be defined as fruity, sweet, apple, berry, blueberry, winy, woody, fatty, green, caramel, citrus-like, etc. The precise odor and taste properties of these compounds vary, depending on the nature of the alcohol ROH used, the specifics of the chemical steps, and the isomeric/enantiomeric composition of the compounds and their mixtures.

The details of one or more embodiments of the invention are set forth in the description below. Other features, objects, and advantages of the invention will be apparent from the description and from the claims.

### DETAILED DESCRIPTION

KCA is a known compound that has been characterized as an intermediate in the bacterial biodegradation of bicyclic monoterpene camphor, and, in particular, in the biodegradation of camphor by Pseudomonas putida ATCC 17453 (Bradshaw, W. H., Conrad, H. E., Corey, E. J. and I. C. Gunsalus, J. Am. Chem. Soc. (1959), 81:5507; Conrad, H. E., DuBus, R. and I. C. Gunsalus, Biochem. Biophys. Res. Commun., (1961), 6, 295.)

Because KCA is a natural product that occurs as an intermediate result of the natural metabolism of camphor in microorganisms, such metabolism provides a means for the preparation of KCA by means of biological oxidation of camphor. Initial reactions in the biodegradation of R- or S-camphor enantiomers by this organism comprise 5-exo-hydroxylation and a dehydrogenase reaction resulting in the formation of 2,5-diketocamphane. The latter compound has been shown to undergo a biological Baeyer-Villiger reaction (keto-lactonization), with the formation of an unstable lactone product that spontaneously forms 2-oxo-4,5,5-trimethylcyclopent-3-enylacetic acid. It has been shown that R and S enantiomers of 2,5-diketocamphane are oxidized by two different enantiomer-specific monooxygenase enzymes (Jones, K. H, Smith, R. T, Trudgill, P. W. J. Gen. Microbiol. (1993) 139(4):797-805). Organisms such as Pseudomonas putida ATCC 17453 and their derivatives known in the art can be used for preparation of a quantity of KCA useful for preparing derivatives on an industrial scale. Other useful microorganisms can be readily isolated by one skilled in the art using known methods such as enrichment techniques with at least one carbon source selected from camphor, or camphor-related compounds comprising borneol, isoborneol, 5-hydroxycamphor (endo- or exo-), and of their respective esters with alkanoic and alkenoic acids or of their respective glycosides.

Other microorganisms can also be used as sources of suitable enzyme activity and corresponding genes that encode monooxygenases capable of forming lactones from camphor and/or 2,5-diketocamphane. Non-limiting examples of such microorganisms include those that are capable of growing on cyclic ketones (cyclopentanone, cyclohexanone, 2-hydroxycyclohexanone, 1,2-cyclohexanedione and the like). Various mutants can be prepared from Pseudomonas putida ATCC 17453 and other organisms to enhance the levels of production of KCA. In addition, the nucleic acids encoding enzymes that are responsible for conversion of camphor to KCA can be cloned in various host organisms such as bacteria, yeast or fungi. Such nucleic acids can further be modified, amplified, and overexpressed. Various methods for directed evolution are well known in the art that allow for improved production of KCA from camphor or camphor-related compounds comprising as borneol, isoborneol, 5-hydroxycamphor (endo- or exo-), and their respective esters with alkanoic and alkenoic acids, or glycosides of the said camphor-related compounds. Such methods comprise mutagenesis, recombination, DNA shuffling, combinatorial gene synthesis and like.

DNA encoding suitable genes for production of the enzymes of interest can also be isolated from the environment using methods known in the art.

In a typical embodiment, an organism such as Pseudomonas putida ATCC C1B 17453, or a mutant derivative lacking enzyme activity required for further degradation of KCA, is grown aerobically in a mineral media on at least one suitable carbon source. The non-limiting examples of suitable carbon sources include carbohydrates, such as hexoses and pentoses, aminoacids, triglycerides and products of their hydrolysis, organic acids such as succinic acid, alcohols such as ethanol, or terpenoids such as camphor and the said camphor-related compounds. Enhancement of production of KCA by Pseudomonas putida C1B ATCC 17453 is typically accomplished by incubation of an effective amount of camphor or the said camphor-related compounds under nitrogen-limiting conditions with effective aeration, until sufficient microbial cell mass has been produced in the culture and sufficient enzyme activity has been induced. Various modifications of the process can be introduced by one skilled in the art. Such modifications may employ the use of free or immobilized microbial cells or cell-free preparations of enzymes comprising camphor 5-hydroxylase and 2,5-diketocamphane monooxygenase.

After a sufficient level of KCA has been attained in the culture broth, the desired compound is typically extracted from the aqueous fermentation medium by various organic solvents. Typically, the fermentation broth containing KCA (free acid and/or salt) is acidified to pH approximately less than 5.5 and extracted with sufficient amounts of water-immiscible solvent, such as ethyl acetate or other esters, ethers such as methyl tert-butyl ether, dicholoromethane, chloroform, ketones, hydrocarbons and mixtures thereof The fermentation broth can be concentrated by partial evaporation of water or even brought to substantial dryness. The nature of the solvent is not critical. However, it is preferred that a non-halogenated biodegradable solvent of low toxicity is used. Alternatively, the entire culture broth containing KCA and salts thereof can be optionally acidified and evaporated to dryness or to a syrup, and the desired compound can be obtained by dissolving in a solvent of suitable polarity or by extraction.

Crude KCA can be purified, if desired, by means of crystallization or vacuum distillation or by solvent partitioning. However, even the crude preparation of KCA can be of sufficient purity so it can be used directly for preparation of KCA esters and other derivatives of the present invention.

Esterification of KCA is typically carried out by reaction with an alcohol. Various alcohols can be used. Examples of preferred alcohols include linear and branched alkanols and alkenols having from 1 to about 10 carbon atoms. Other examples include alcohols having cycloalkane or cycloalkene rings or aromatic rings. Other examples include polyhydric alcohols having two or more hydroxyl groups. Examples of polyhydric alcohols include ethylene glycol, propylene glycol, neopentyl alcohol, dihydroxycyclohexane isomers, glycerol, sorbitol, inositol and the like. The esters of KCA with polyhydric alcohols can comprise one or more fragments derived from KCA. The esters of KCA with polyhydric alcohols can also include one or more fragments of other carboxylic acids. The esters of KCA with polyhydric alcohols, akin to the KCA esters with monohydric alcohols, can be used to prepare many other derivative compounds desribed herein.

Esterification is typically carried out in the presence of an acid catalyst. The nature of the acid catalyst is not critical. Sulfuric acid, hydrochloric acid, phosphoric acid, acidic resins having protonated sulfonic groups, toluene sulfonic acid, camphorosulfonic acid and like can be used. Esters of KCA and acid-sensitive alcohols can also be prepared by transesterification of an ester of ketocampholenate and monohydric or a polyhydric alcohol, by adding an acid sensitive alcohol, typically in the presence of an excess of such acid-sensitive alcohol and in the absence of water, and in the presence of base such as alkali metal alkoxide or alkali metal hydroxide. Esterification of KCA to form esters of tertiary alcohols can also be carried out with alkenes in the presence of an acid catalyst. Esterification can also be carried out enzymatically, for example, by using a lipase or an esterase in low water solvent systems, using free or immobilized enzymes. Esterases and lipases can also be used in trans-esterification reaction of lower alkanol esters of KCA with other alcohols. Esterases and lipases are also useful for conducting esterifications, transesterifications and hydrolysis reactions useful for separating one or more isomers, including stereoisomers or positional isomers of compounds (1) through (6) from mixtures of such isomers that have been prepared by non-stereoselective chemical methods.

The KCA esters described herein are novel compounds that possess very attractive olfactory properties such as odor and taste.

The carbonyl group of the KCA or its salt or ester can be reduced to a hydroxyl group. Various methods of reduction of carbonyl compounds are well known in the art. The carbonyl group may also be reduced biologically by using various microorganisms, and yeasts, preferably, baker's yeast The reduction may also be carried out enzymatically by using various isolated oxidoreductases or dehydrogenases. The reduction can be carried out by using a free KCA, or a salt, or an ester thereof. When esters of KCA are reduced, the resulting esters of formula (3) also have attractive olfactory properties. 2-hydroxy-4,5,5-trimethylcyclopent-3-enylacetic acid or the esters of formula (3) can also be converted to novel lactone compounds of general formula (4). The reduction of carbonyl group can be also carried by means of methods known in the art and exemplified by hydrogenations, alkali metal borohydrides and alkali metal aluminum hydrides, or under Meerwein-Ponndorf-Verly conditions, and the like. Depending on the enantiomeric composition of camphor (or derivative of camphor) used to prepare the KCA, and the stereoselectivity of particular methods used for reduction of carbonyl group, various stereoisomers of the lactone (4) can be prepared. Such lactone compounds have very attractive scent and flavor characteristics.

Reduction of the KCA or ester or salt or unsaturated lactone (4) can be carried out in a way allowing for reduction of the double bond in the cyclopentene ring, thereby allowing for preparation of saturated compounds having formulae (2),(3) and (4). Such reduction can be carried out chemically, or for KCA or KCA ester, biologically using baker's yeast. Chemical reduction is carried out typically by a catalytic hydrogenation for practical purposes of industrial production of the compounds having formulae (2),(3) and (4), typically by using Pd/C or other palladium or platinum catalyst. Many various reduction methods are known in the art. If desired, hydrogenation or other reduction can be performed under conditions that allow for reduction of the double bond and the carbonyl group in one operation, and even carboxyl groups or carboxyl esters can be reduced contemporaneously with carbonyl group of the cyclopentane or cyclopentene ring, in particular, when reduction of the carbonyl group of the cyclopentene or cyclopentane ring is carried out using esters (1) or esters (2) using lithium aluminum hydride or sodium borohydride as reducing reagents. Such reduced compounds are novel, and the esters (2),(3) and lactones (4) without double bond have attractive olfactory properties attractive for use as odorants in, e.g., perfumes and/or as flavors.

If reduction of carbonyl group of esters (1) or (2) to secondary hydroxyl group is also accompanied by reduction of the carboxyl group to a primary alcohol, the diol compounds of formulae (5) and (6) can be prepared:

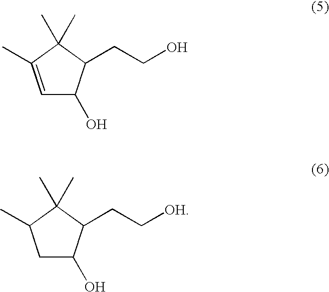

The compounds (5) and (6) are found herein to be useful for making novel odoriferous compounds with pleasing olfactory properties. The compound (5) upon exposure to acid has been found to undergo a rapid cyclization and isomerization to practically pure bicyclic ether compound of formula (7), with small amounts of isomeric compounds (7a) and (7b):

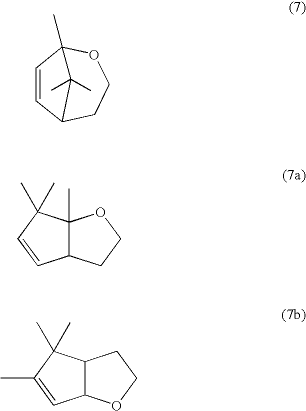

Purified compound (7) had a strong warm eucalyptus-like soft pleasant odor that is similar to the odor of 1,8-cineole and fenchones, but does not exhibit musty sharp notes attributable to the scents of the latter two compounds.

The compound (6) was readily cyclized in the presence of acid catalyst to give isomers of formula (8) that have camphoraceous woody ethereal odor.

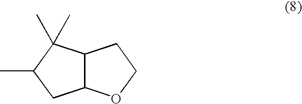

The compound (6) is also useful to make acetals and ketals of formula (9):

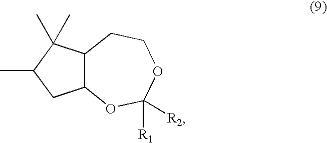

wherein R₁ and R₂ are each independently H or R, as defined above for formula (1). For example, such esters can be made by methods known in the art involving reaction with a ketone or aldehyde, or by exchange reaction with ketals or acetals, in the presence of acid catalyst These compounds are useful to obtain a variety of characteristic odors, and in particular, a mixture of stereoisomers of compound (9), wherein R₁ and R₂ are both methyls, has been found herein to possess a pleasant sweet camphoraceous woody amber-like odor.

In another embodiment of the present invention, the hydroxyacid esters of formula (3) or corresponding free acids or salts thereof, or lactones of formula (10) can be dehydrated to afford preparation of isomeric campholenic acid esters of formula (11):

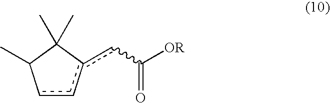

wherein any one dashed bond is a double bond, and the other two are single bonds, and wherein the wiggled bond has E or Z configuration,

and the isomeric diene compounds of formula (11):

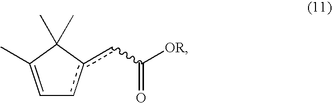

wherein any one dashed bond is double and the other is single.

These compounds also have attractive and powerful organoleptic properties, such as scent and taste, making them useful as flavor and fragrance compounds. They can be used in substantially pure form or as admixtures of isomers.

Dehydration of hydroxyacid esters of formula (3) or corresponding free acids or salts thereof, or lactones (4), or mixtures of hydroxyacid esters (3) with lactones (4) can be carried out by one or more methods known in the art for dehydration of secondary alcohols or esters to corresponding alkene compounds. Non-limiting examples of such methods include treatments with acids of sufficient strength, such as sulfuric acid, phosphoric acid, or with strong alkali, or by converting the hydroxyl compound to a carboxylic ester with carboxylic or polycarboxylic acid (e.g. acetic ester, propionic ester, benzoic ester, phthalic ester, maleic ester, adipic ester, citric ester and like), or by converting the hydroxyl group to a sulfonic ester (i.e. toluenesulfonic ester, metanesulfonic ester, camphorosulfonic ester and like). The elimination reaction is typically carried out at elevated temperatures, with or without additional catalysts or reagents, at temperatures sufficient to cause elimination of water or carboxylic acid or sulfonic acid and form the desired cyclopentene or cyclopentadiene compounds (5) and or (6). If elimination is carried out under acidic conditions, depending on severity of the treatment (i.e. amount of acid, temperature, or presence of isomerization catalyst, such as palladium, palladium oxide or salts thereof), migration of the double bond can occur to the side chain possessing the carboxyl group, thereby resulting in the formation of α,β-unsaturated carboxylic acid or ester thereof. Depending on a particular composition and stereoisomer ratio of the starting materials for dehydration comprising the hydroxyacid esters of formula (3) or corresponding free acids or salts thereof, or lactones of formula (4), and depending on a particular method of hydroxyl group elimination and conditions of treatment, various mixtures of isomeric compounds of formula (10) and (11) can be prepared. However, such mixtures are fully devoid of any appreciable detectable or olfactory effective amounts of α-campholenic, β-campholenic and γ-campholenic esters, as all these compounds possess different mass-spectra, different retention times by gas chromatography (GC), and, as it has been found herein, while they have a generally similar type of odor, they have significant odor character differences and odor potency.

The compounds of formula (10) and (11), and mixtures comprising these compounds, have very attractive olfactory characteristics, and can be used as such, or with addition of α-campholenic, β-campholenic or γ-campholenic esters, if so desired, to create and modify a broad range of flavor compositions using general methods, for example methods akin to those described for uses of α-campholenic, β-campholenic or γ-campholenic esters in the U.S. Pat. Nos. 4,547,315, 4,590,953, 5,030,467, 5,057,158 and 5,164,364.

In another embodiment of the present invention, KCA or ester having formula (1) is epoxidized at the double bond of the cyclopentene ring by one of the methods known in the art. Epoxidation is typically carried out by hydrogen peroxide, under neutral or slightly or strongly alkaline conditions. The resulting epoxide of formula (12):

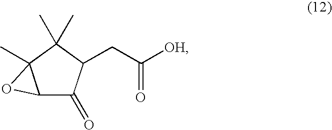

or salt or ester thereof, can further be converted to cyclopentenolone compounds represented by two interconvertible tautomers having formulae (13a) and (13b):

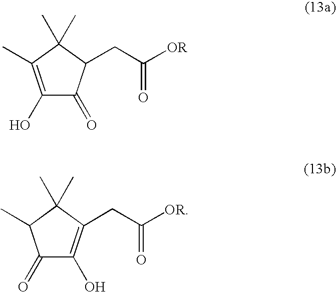

Conversion of the epoxide (12) to the cyclopentenolones (13a and 13b) is typically carried out by contacting the said epoxide with silica or alumina in the presence of suitable solvent, such as ether, hexanes, dichloromethane or esters. Alternatively, the epoxide can be hydrolyzed in the presence of acid catalyst and then further dehydrated to the cyclopentenolones under acidic conditions. Hydrolysis or alcohololysis and dehydration steps can be carried contemporaneously without isolation of intermediate products. Cyclopentenolones 13a and 13b can further be converted to a cyclic cyclopentenolone ester having formula (14), typically under conditions that allow for removal of water or alcohol ROH by an azeotropic distillation:

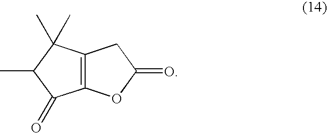

Cyclopentenolones 13a, 13b and their enol ethers, and compound 14 are novel compounds having attractive olfactory properties, and thus useful as perfume and flavor compounds. These compounds possess a powerful pleasant sweet odor and taste resembling caramel, maple syrup and fruits.

When the epoxidation step is carried out under strong alkaline conditions with hydrogen peroxide, isomerization of KCA via retro-aldol and aldol reactions takes place:

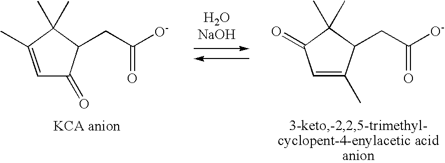

While the equilibrium of this retroaldol-aldol isomerization favors KCA, the isomeric 3-keto-2,2,5-trimethyl-cyclopent-4-enyl acetic acid anion can be trapped by the epoxidation process and, upon hydrolysis or isomerization of the epoxy group, and upon esterification form isomeric cyclopentenolone compound formula (13c) that have scent character similar to cyclopentenolones (13a) and (13b).

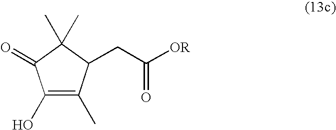

When the epoxidation reaction is carried out with free KCA or a salt thereof, subsequent esterification of epoxy derivative of KCA under acidic conditions in the presence of a suitable alcohol results directly in the formation of three cyclopentenolone enol ethers (15a), (15b) and (15c) in about equal amounts:

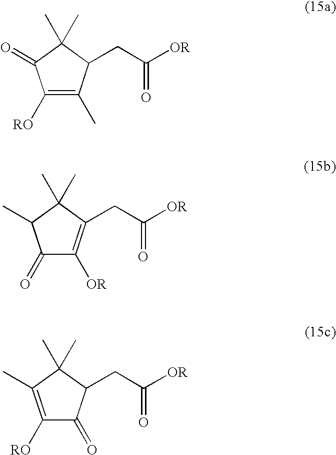

Compounds of formulae (15a), (15b) and (15c) have odor characteristics similar to compounds (13a), (13b) and (13c). Compounds of formulae (14), (15a), (15b) and (15c) were found herein to undergo rapid hydrolysis of enol ether group in the presence of moisture or in the presence of any traces of acid or base. As result of such hydrolysis, the odor of the mixture of these compounds becomes more potent and displays more pleasant caramel-like sweet fruity character.

In a related embodiment, KCA is first treated with strong aqueous alkali or with concentrated aqueous sodium or potassium carbonate, without addition of hydrogen peroxide, to cause isomerization of the cyclopentenone ring via retro-aldol and aldol reactions in order to prepare isomeric 3-keto-2,2,5-trimethyl-cyclopent-4-enyl acetic acid. The latter compound, upon subsequent esterification, allows for preparation of a series of novel ester compounds having formula (16):

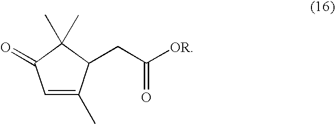

The compounds of formula (16) have powerful scents that are very different from relatively faint odors of esters of KCA. The compounds of formula (16) generally possess a strong maple syrup sweet fruity character. For example, the scent of compound (16) wherein R is ethyl, can be readily recognized in the mixture with ethyl ester of KCA with the ratio of two compounds (1):(16) is in the range about 1:200.

In yet another embodiment of the present invention a convenient and practical method is provided for making α-campholenic (2,2,3-trimethylcyclopent-3-enylacetic) acid ester of formula (17), 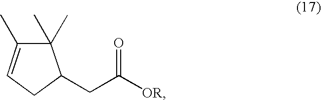
wherein the compound of formula 17 is produced in substantially pure state or optionally as a mixture that contains variable amounts of γ-campholenic acid esters, or optionally contains isomers of esters of formulae (10) or (11).

The esters of formula (17) are known compounds that have attractive olfactory properties. It has now been found that the esters of formula (17) can be prepared by means of a process comprising

a) biological oxidation of camphor, or of a suitable camphor precursor selected from camphor-related compounds comprising borneol, isoborneol 5-hydroxycamphor (endo- or exo-), and of their respective esters with alkanoic and alkenoic acids or of their respective glycosides, thereby providing at least one enantiomer of 1,2-campholide of formula (18) and/or of 3-hydroxy-2,2,3-dimethylcyclopentanylcetic acid (19):

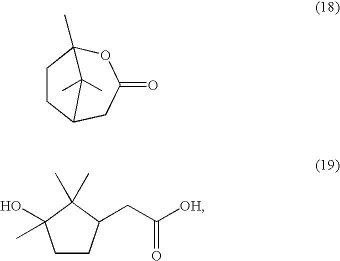

b) recovering 1,2-campholide and/or 3-hydroxy-2,2,3-dimethylcyclopentanylcetic acid by means of solvent extraction under neutral or acidic condition with a water-immiscible solvent, or by steam distillation,

c) converting 1,2-campholide to 3-hydroxy-2,2,3-dimethylcyclopentanylcetic acid ester by a transesterification reaction with substantially anhydrous alcohol, or an ester thereof, in the presence of a suitable base, typically alkali metal hydroxide or alkali metal alkoxide, or sodium carbonate or potassium carbonate, or trisodium phosphate, or an esterase enzyme, or lipase enzyme,

d) dehydrating 3-hydroxy-2,2,3-dimethylcyclopentanylcetic acid ester under acidic conditions and/or under elevated temperatures sufficient to cause dehydration, thereby providing the desired α-campholenic acid ester (17).

The step (d) can be accomplished by using a strong mineral acid, such as sulfuric acid, or by using a protonated form of a strongly acidic cation exchange resin comprising sulfonic acid groups, or by using phosphoric acid or an alkali-metal phosphate solution buffered to pH in the range between 1 and 5, or by adding suitable amounts of carboxylic acids such as citric acid or succinic acid and the like.

Depending on the severity of the treatment, such as in the presence of strong mineral acids and at elevated temperature, some amounts of 3-hydroxy-2,2,3-dimethyl-cyclopentanylcetic acid esters can re-form 1,2-campholide, thereby leading to the Wagner-Meerwein rearrangement known in the art, and resulting in the formation of various amounts of γ-campholenic acid and its esters. Formation of γ-campholenic acid and its esters does not impair olfactory and taste properties of the resulting campholenate ester mixture, and in fact, is advantageous as γ-campholenic acid esters possess more distinctive scent and taste properties in comparison with the c-isomer.

The biological oxidation is carried out by a suitable microorganism that possesses sufficient cycloalkanone monooxygenase or 2,5-diketocamphane monooxygenase that is capable of acting on at least one enantiomer of camphor, provided that such microorganism lacks substantial activity of camphor hydroxylating enzymes such as camphor 5- or 6-monooxygenase. In practice, such microorganisms can be readily obtained, for example, by mutating or deleting at least one gene encoding at least one component of camphor -5-hydroxylase of Pseudomonas putida ATCC 17453, thereby rendering it inactive. Another type of suitable microorganism is a heterologous host microbial strain that expresses at least one functional cycloalkanone monooxygenase (“Bayer-Villiger” monooxygenase), such as cyclohexanone monooxygenase. Numerous organisms of this type are known in the art. One of skilled in the art can use various methods for expressing cycloalkanone monooxygenase capable of ketolactonization of camphor. Bacteria, yeasts, and fungi comprise suitable microbial hosts for expressing said monooxygenase. Various methods exist in the art that can increase or otherwise enhance catalytic properties of cycloalkanone monooxygenase for the purpose of increasing rate and quantity of the produced 1,2-campholide. Such methods include various directed evolution techniques comprising mutagenesis, recombination, DNA shuffling, combinatorial gene synthesis and like. Formation of campholide (18) by Pseudomonas putida ATCC 17453 cells grown in the presence of camphor or a suitable precursor thereof is usually accompanied by the formation of small variable amounts of 5-hydroxycampholide. In particular, the presence of 5-hydroxycampholide is pronounced when the cells of this organism retain significant hydroxylation activity due to camphor-5-hydroxylase, typically during the exponential phase of growth of this organism on camphor. If 1,2-campholide is not purified from 5-hydroxycampholide, the latter compound undergoes similar reactions under conditions of steps b) through d) described above for conversion of campholide, and hence small amounts of compounds of formula (11) are formed. The presence of such compounds in campholenic acid esters is desirable, as compounds of (11) have more potent odor and add a unique pleasant character to the mixture.

The method for production of α-campholenic acid esters described in the present invention has advantages over known methods that involve rearrangement of α-pinene epoxide to α-campholenic aldehyde. Preparation of the α-pinene epoxide, campholenic aldehyde and oxidation of the aldehyde to the α-campholenic acid by methods known in the art involves use of hazardous reagents and commands high costs. The resulting campholenate esters prepared by such methods are synthetic products that do not qualify for the status of “natural” flavor or fragrance ingredients.

In respect to conversion of campholide to α-campholenic acid esters, the present invention is not limited to use of the specific examples described herein for performing the steps a) through d) above. Many variations can be used for this process by one of ordinary skill in the art. The present invention explicitly includes a variation of converting either enantiomer of natural camphor or a suitable natural precursor thereof, such as borneol, isoborneol and their esters commonly found in many plant essential oils and extracts, to prepare α-campholenic acid esters that qualify for natural flavor status and natural flavor labeling on the products comprising such α-campholenic acid esters. In particular, this embodiment is carried out as part of the preparation of campholide, by using a natural microorganism capable of utilizing camphor via a pathway comprising 5-hydroxylation and/or biological Baeyer-Villiger oxidation, wherein the strain has or has not been modified by means of genetic engineering or mutagenesis. Furthermore, this embodiment comprises variations of all steps b) through d) wherein only those solvents and reagents are used that are permitted in natural flavor preparations. For example, alcohols required for preparation of ester group in step c) are isolated from natural sources or prepared by means of fermentation, and the reaction is performed using the enzymes or GRAS materials permitted as food additives or ingredients. In this embodiment, dehydration step d) is carried out by combination of mild heating in the presence of food grade citric acid, phosphoric acid or phosphate buffer, and this step can be contemporaneous with steam distillation or distillation under reduced pressure to obtain natural campholenate esters of suitable purity for flavor or perfumery applications.

In an alternative variation of the present invention for preparation of campholenic acid derivatives from camphor, the biological oxidation of camphor is carried out by microorganisms using an alternative oxidation pathway known in the art. This pathway is initiated by 6-hydroxylation of camphor and results in the formation of 2,6-diketocamphane. A typical microorganism that possesses such pathway is a Rhodococcus sp. T1 (NCIMB 9784), formerly described as Mycobacterium rhodochrous or Corynebacterium sp. T1 (P. J. Chapman, et al, 1966, J. Am. Chem. Soc., 88:618). The 2,6-diketocamphane is a β-diketone that undergoes a biological or chemical hydrolytic cleavage, thereby yielding a known metabolite (3-keto-4,5,5-trimethylcyclopentaneacetic acid), which is practically odorless in a pure form. This compound can be esterified to yield an ester of formula (20), which has a relatively faint but pleasant fruity-woody rum-like scent:

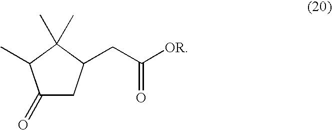

The carbonyl group in the compound (20) can be reduced by any methods known in the art to yield one or more stereoisomers of formula (21) that have relatively weak fruity-floral-woody odors:

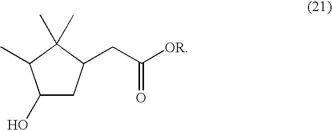

The isomers of the compound (21) are found herein to be useful for making α-campholenic esters of formula (17) and the isomeric cyclopentene compound of formula (10a):

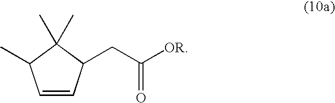

The relative amount of compounds (17) and (10a) depends on the composition of stereoisomers in the compound mixture having formula (21). The mixtures of compounds (17) and (10a) have odors similar to α-campholenic esters, however, they have a pronounced powerful sweet mouthwatering note.

Campholides for making campholenic acids, and numerous ketocampholenic acid derivatives according to methods described herein above, can be prepared from substantially pure camphor or suitable precursor thereof or from mixtures of comprising different terpenoids, such as found in many essential oils or plant extracts, or from mixtures of terpenoids that are created by combining various individual natural or synthetically made terpenoids and/or mixtures of terpenoids, or industrially available derivatives thereof. Such terpenoid mixtures may include acetylated essential oils or saps or resins or extracts, exemplified by acetylated cedarwood oil or vetiver oil. In many such instances, structurally related cyclic terpenoids can be biologically co-oxidized by one or more enzymes of camphor biooxidation pathways. For example, structurally related to camphor, bicyclic terpene ketone fenchone often co-occur in essential oils. Such structurally-related compounds undergo a series of oxidative reactions when contacted with one or more organisms each expressing one or more camphor biooxidation pathways, or, optionally, pathways for oxidative metabolism of other terpenoids.

For example, when ketocampholenic acid (1) or campholide (18) or ketocampholanic acid (20) are being prepared by biological oxidation using camphor-utilizing organisms from starting materials comprising camphor and fenchone, the latter compound also undergoes limited biotransformation comprising at least one oxidative biological step involving cleavage of one carbon-carbon bond. Such cleavage results in the formation of corresponding lactones from fenchone-1,2-fencholide (21) and 2,3-fencholide (22), 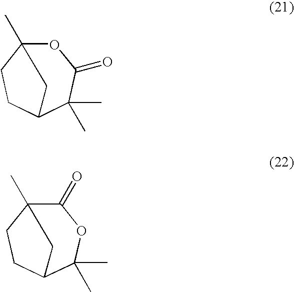
due to activity of a Baeyer-Villiger type of monooxygenase enzyme. Microorganisms with various monooxygenase of this type can produce fencholides in different ratios, and may optionally act on other ketone derivatives of cyclic terpenoids. Other compounds that are biologically co-oxidized with camphor, and via reactions akin to those of camphor pathways, can therefore contribute to the formation of various metabolic by-products.

Such co-oxidation by-products, or mixtures thereof, when present in compounds obtained by biological oxidation of cyclic terpenoids (exemplified herein by camphor enantiomers), can significantly influence scent and taste properties of various derivative compounds and mixtures of such derivative compounds prepared by subsequent chemical reactions comprising esterifications, trans-esterifications, reductions, oxidations, isomerizations, elimination and carbon-carbon bond formation or cleavage reactions. When terpenoid co-oxidation by-products are isolated, or prepared intentionally by microorganisms capable of performing cleavage of carbon-carbon bonds in cyclic terpenoids, or cleavage of oxygen-containing ether or lactone rings in cyclic terpenoids, the attractive olfactory properties of chemical derivatives, made by the above-referenced chemical reactions, can be revealed. This embodiment of the present invention is demonstrated herein by preparation of odoriferous compounds from fenchone that has been oxidized by camphor-degrading microorganism Rhodococcus sp. T1 (NCIB 9874) that also possesses an oxidative pathway allowing for utilization of fenchone as a sole carbon source. While this organism is not know to oxidize camphor to 1,2-campholide via biological Baeyer-Villiger reaction, and thereby uses a different route for camphor metabolism, the strain nevertheless possesses a useful Baeyer-Villiger oxidation activity in respect to oxidation of fenchone to a mixture of fencholides. The ability of cells to form fencholides is manifested when this organism is grown in the presence of at least one fenchone or fenchyl alcohol enantiomers. The resulting fencholides possess relatively weak characteristic odor. However, when treated under acidic conditions in the presence of an alcohol, allowing for esterification and elimination reactions, the fencholides are converted to a mixture of series of carboxylic esters represented by formulae (23) through (28):

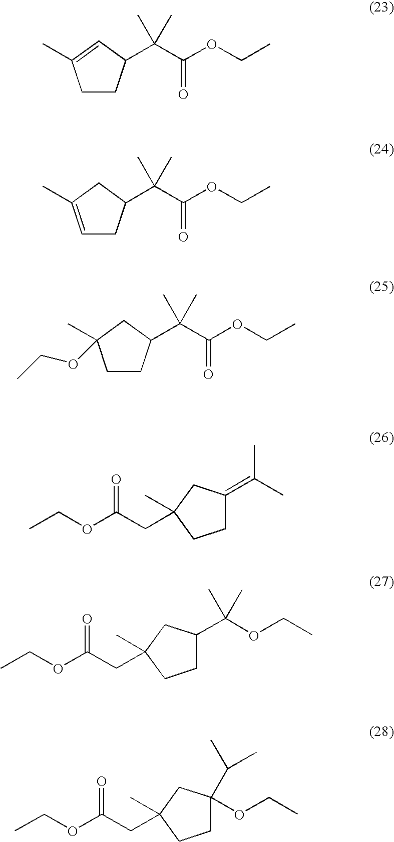

Such compounds have been found herein to possess strong pleasant odor reminiscent of fennel oil and pickled vegetables, and to have a pleasant warm woody-fruity note.

The present invention demonstrates herein the approach for preparation of a broad range of various odoriferous compounds with pleasant scent characteristics useful in creating and modifying various flavor and fragrance compositions for use in multiple applications. The approach described herein is based on a combination of

a) step comprising biological microbial oxidation of cyclic terpenoids wherein the biological oxidation results in cleavage of at least one product wherein carbon-carbon bond in the ring or cleavage of a ring comprising oxygen heteroatom takes place, and

b) at least one chemical reaction comprising esterifications, trans-esterifications, reductions, oxidations, isomerizations, elimination and carbon-carbon bond formation or cleavage.

The usefulness of this approach spans from simple individual terpenoid compounds to mixtures of isomers and enantiomers thereof, and to terpenoid compounds that have been chemically modified prior to conducting the biological oxidation step. Terpenoids are compounds that originate by natural biosynthesis from isoprene units, such as isoprenol diphoshate and dimethylallyl diphosphate, or by means of chemical synthesis from isoprene or other terpenoids. Industrially useful examples of terpenoids for practicing the present invention include compounds that have been chemically modified, for example by means of esterification, reduction or oxidation, isomerization, elimination, by various carbon-carbon and carbon-oxygen bond forming reactions comprising acylation of double bonds, additions of Grignard compounds to terpenoid ketones, by Witting reaction with terpenoid ketones, or by inter- or intra-molecular photoadditions, by Prins reaction and by combinations thereof.

This approach is useful in transforming a variety of terpenoid compounds into a multitude of new compounds possessing an exceptionally broad spectrum of attractive odors. These new compounds are useful as flavors and fragrances to impart various original scent and taste properties to many products that include, for example, perfumes, colognes, hair care products, cosmetic bases, cleaners, sanitary detergents, shampoos, hair rinses, hair tonics, hair creams, pomades, face powders, lipsticks, soaps, kitchen detergents, laundry detergents, softeners, disinfectants, detergents, deodorants, room aromatics, candles, furniture care products, disinfectants, various foodstuff, beverages, alcoholic beverages, liqueurs, chewing gums, candies, pastries, tobacco, cakes, cookies, margarines, butter, cooking oils, toothpastes, mouth washes, disinfectant mouth washes, and the like.

### EXAMPLE 1

9.22 grams of 99.2% pure ketocampholenic acid, obtained by biological oxidation of R(+)-camphor, were dissolved in 50 ml of absolute USP-grade ethanol, and 0.1 ml of concentrated sulfuric acid was added, and the solution was refluxed for 2 hours. Finely powdered calcium carbonate (0.5 g) was added to the reaction mixture, and the reflux was continued for additional 1 hour. The resulting solution was filtered, and ethanol was distilled out under reduced pressure. The resulting crude product (clear colorless oil) was dissolved in hexane, dried over anhydrous magnesium sulfate, filtered and evaporated under reduced pressure to give 10.24 g of the ethyl ester of ketocampholenic acid (1a) as a clear colorless oil that was found to be over 99.6% pure by GC and GC-MS:

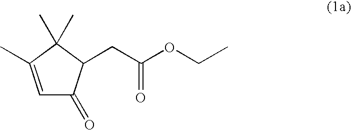

Mass-spectrum (obtained at 70 eV electron ionization) of the compound (1a) had the characteristic series of ions with the following m/z (% abundance):210 (59, M⁺), 195 (80), 182 (3.5), 165 (76), 149 (19), 137 (100), 123 (43), 121 (48), 109 (37), 93 (32), 79 (19), 67 (23), 55 (10), 41 (13).

The compound (1a) had the following ¹H NMR spectrum in CDCl₃, 55 mg/ml, (δ, ppm): 1.004 (3H, s), 1.225 (3H, s), 1.256 (3H), 2.010 (3H, s), 2.304 (1H), 2.734 (2H), 4.158 (2H), 5.797 (1H).

The compound (1a) had a faint, pleasant, sweet, fresh, citrus-like scent with a muffled vanilla-like note.

### EXAMPLE 2

8.05 grams of ketocampholenic acid were dissolved in 50 ml of absolute USP-grade ethanol, and 2 grams of ethanol-washed protonated form of Amberlyst-15 strongly acidic cation exchange resin were added. The reaction mixture was set on reflux for 12 hours. After that, the solution was cooled, filtered, and ethanol was distilled out under reduced pressure. 30 ml of hexane were added to the resulting crude product, stirred for 30 minutes at room temperature and cooled to 5° C. The undissolved material comprising primarily non-esterified compound was removed by filtration. The filtrate was evaporated under reduced pressure to give 7.33 grams of practically pure compound (1a) that had identical spectra and olfactory properties as the compound prepared according to Example 1.

### EXAMPLE 3

The synthesis was carried out as in Example 1, except the quantity of ketocampholenic acid used was 3.20 g, 20 ml of methanol was used as esterifying alcohol, and the solution was refluxed for 3 hours prior to addition of calcium carbonate. After the work-up, the resulting clear oil (3.02 g) was analyzed by GC and GC-MS, and was found to be 99.3% pure methyl ester of ketocampholenic acid having formula (1b):

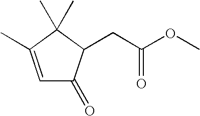

The compound (1b) had a scent very similar to compound (1a) except the character of the scent was more pronounced.

The mass-spectrum of compound (1b) showed a series of characteristic ions with m/z (% abundance): 196 (43, M⁺), 181 (100), 165 (36), 154 (10), 149 (14), 137 (52), 121 (43), 109 (24), 93 (32), 79 (16), 67 (18), 55 (7), 41(10).

### EXAMPLES 4A and 4B

2.00 grams of compound (1a) obtained in Example 1 were dissolved in 15 ml of ethanol, and 8 mg of 10% PdO on calcium carbonate (example 4A), or of 10% Pd on carbon (example 4B) were added. The whole was purged with hydrogen and hydrogenated at 25° C., 3.5 atm hydrogen pressure, for 18 hours.

After hydrogenation, the solution was filtered and the solvent was removed under reduced pressure to yield about 1.96 grams (example 4A) or 1.93 grams (example 4B) of clear colorless oil. The material was analyzed by GC, GC-MS and revealed no appreciable quantities of the starting material (1a). The hydrogenation yielded two isomeric products (2a) and (2b) in the ratio of about 1:9 (example 4B), or of about 1:4.5 (example 4B), correspondingly:

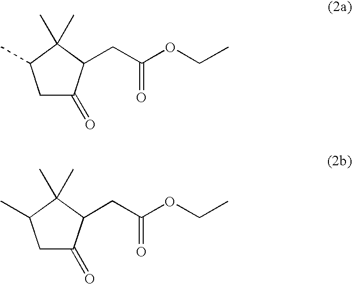

The mass-spectrum of the trans-isomer (2a) had a series of characteristic ions with m/z (% abundance): 212 (5, M+), 197 (100), 183 (0.2), 167 (29), 151 (97), 139 (54), 128 (10), 123 (43),109 (9), 96 (27), 81 (6), 69 (84), 55 (21), 41 (28).

The mass-spectrum of the cis-isomer (2b) had a very similar series of characteristic ions with m/z (% abundance): 212 (2, M+), 197 (100), 183 (0.1), 167 (27), 151 (94), 139 (48), 128 (10), 123 (39),109 (7), 96 (25), 81 (7), 69 (67), 55 (25), 41 (21).

¹H NMR of the mixture from example 4A showed the following signals (CDCl₃, 50 mg/ml), (δ, ppm): 0.595 (3H, s), 0.975 (3H), 1.055 (3H, s), 1.232 (3H), 1.754 (1H, m), 2.045 (1H), 2.130 (2H), 2.385 (2H), 2.582 (1H), 4.112 (2H).

The mixture of compounds (2a) and (2b) had a faint, pleasant, sweet, fruity odor with a note reminiscent of coconut.

### EXAMPLE 5

2.76 g of compound (1a) were dissolved in 25 ml of methanol and stirred at room temperature. 3.3 g of sodium borohydride were added in small portions over 1 hour while the reaction mixture was stirred. The reaction was slightly exothermic and the addition resulted in the temperature of reaction mixture rising to 45-50° C. After complete addition, the reaction mixture was cooled to room temperature (25° C.) and was stirred for an additional 2 hours. Methanol was distilled out under reduced pressure, and 10 ml of water were added to the remaining solids. The solution was acidified to pH about 2-3 by dropwise addition of 20% sulfuric acid in water, while maintained on an ice bath. The resulting mixture was extracted 3 times with 30 ml of ethyl acetate, the extracts were combined, dried over anhydrous sodium sulfate, filtered and evaporated under reduced pressure to give 2.65 g of white oily solids. 25 ml of hexane were added to the solid residue, and the whole was stirred for 10 minutes. The resulting suspension was filtered, and the hexane solution was evaporated under reduced pressure to give 850 mg of clear colorless oil (fraction A). The material from the filter was dissolved in ethanol, and the solution was evaporated to give 1.72 g of white solids (fraction B) that were found to comprise primarily stereoisomers of 2-hydroxy4,5,5-trimethylcyclopent-3-enylacetic acid (55%), about 25% of 2-hydroxy4,5,5-trimethylcyclopentylacetic acid, and about 15% of unchanged compound (1a).

The fraction A was found by GC and GC-MS to contain about 98% of two lactone compounds (4a) and (4b) in the ratio about 1:3, correspondingly:

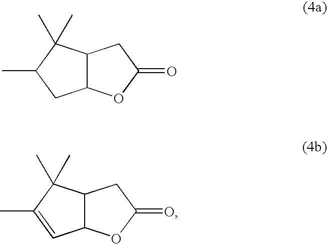

The mass-spectrum of compound (4a) had a series of characteristic ions with m/z (% abundance): 166 (3, M⁺), 151 (4.5), 137 (0.8), 122 (23), 109 (27), 107 (100), 95 (8), 91(22), 79 (12), 67 (7), 55 (4), 41 (7).

The mass-spectrum of compound (4b) had a series of characteristic ions with m/z (% abundance): 168 (4.5, M⁺), 153 (5), 150 (3.5), 135 (3.5), 126 (6), 123 (3), 108 (59), 84 (100), 69 (97), 55 (19), 41 (28).

The mixture of lactones (4a) and (4b) had a very characteristic mild fresh, lactonic, fruity scent with a pleasant undertone reminiscent of a good unlit cigar.

### EXAMPLE 6

5.15 grams of ethyl ketocampholenate (1a) prepared in Example 1 were dissolved in 30 ml of absolute USP-grade ethanol. 1.6 g of sodium borohydride was added in small portions over 15 minutes. The reaction was mildly exothermic, and the temperature was allowed to rise to 55° C. The reaction mixture was stirred for an additional 1 hour, while gradually cooling to room temperature (25° C.). The resulting solution was brought to dryness by distilling out ethanol under reduced pressure. 15 ml of water were added to the resulting solids and the solution was acidified by dropwise addition of 5 ml of 40% sulfuric acid in water, while allowing temperature to rise to 50° C. During acidification, a powerful eucalyptus-like odor of the reaction mixture was noticed.

The resulting acidified solution was extracted 3 times with 20 ml of hexane, and the hexane extracts were combined, dried over anhydrous sodium sulfate and evaporated under reduced pressure, thereby yielding 3.13 g of a clear colorless oil (fraction A). The oil was analyzed by GC and GC-MS and found to comprise about 94% of an ether compound having formula (7), traces of ethers (7a) and 7 (b), small amounts of lactones (4a), (4b) and unreacted starting material (1a).

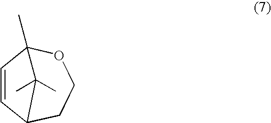

The compound (7) was optically inactive (racemate) due to epimerization of the starting material prepared by esterification under acidic conditions.

Mass-spectrum of compound (7) had a series of characteristic ions with m/z (% abundance): 152 (38, M⁺), 137 (80), 134 (6), 124 (12), 119 (10), 109 (100), 107 (67), 95 (30), 93 (20), 91 (43), 81 (30), 79 (20), 77 (15), 55 (11), 41 (17).

The compound (7) had the following ¹H NMR spectrum in CDCl₃, (94% pure, 60 mg/ml), (δ, ppm): 0.994 (3H, s), 1.033 (3H, s), 1.302 (3H, s), 1.754 (2H, m), 2.483 (1 dd), 3.643 (2H,m), 4.882 (1H), 5.210 (1H).

The novel monoterpene ether compound (7) prepared herein had a very warm and powerful pleasant eucalyptus-like odor reminiscent of pure 1,8-cineol and of pure fenchone enantiomers. However, the odor of compound (7) was more pleasant that the odor of the latter two compounds as it was devoid of sharp, musty, pungent, unpleasant notes present in the odor of 1,8-cineol and fenchones.

The aqueous phase remaining after hexane extractions of the reaction mixture was extracted 3 times with 20 ml of ethyl acetate, and the extracts after usual work-up yielded 1.70 g of white solid (fraction B) that comprised primarily a mixture of isomers of a dihydroxy compound represented by general formulae (5) and (6):

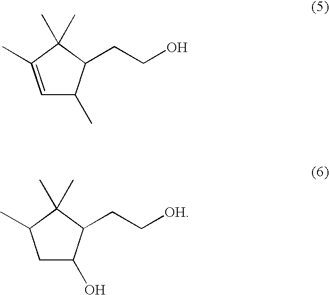

The compound (5) underwent gradual cyclization to compound (7) over several days upon standing at room temperature in the presence of even minute traces of acid, while the compound (6) remained largely unchanged during storage at room temperature and was readily separable from compound (7) by dissolving the latter compound in hexane.

200 mg of 96% pure compound (6) was converted to ether compound of formula (8) by refluxing for 2 hours in 10ml of hexane in the presence of 0.010 ml of concentrated sulfuric acid. The reaction mixture was neutralized by addition of 100 mg of calcium carbonate. After refluxing for additional 30 minutes, the solution was filtered and evaporated to give 116 mg of clear colorless oil that was found to comprise about 96% of ether stereoisomers represented by formula (8).

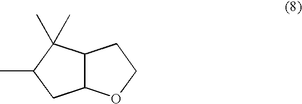

The major isomer of compound (8) had a mass-spectrum comprising characteristic peaks with m/z (% abundance): 154 (8, M⁺), 139 (19), 121 (7), 111 (100), 97 (32), 95 (15), 83 (80), 70 (31), 67 (22), 55 (57), 41 (27).

The sample of compounds represented by formula (8) had a camphoraceous woody odor.

The compound (6) was also converted to a ketal of formula (9a) by reaction with excess 2,2-dimethoxypropane in the presence of catalytic amounts of acid catalyst (Amberlyst 15):

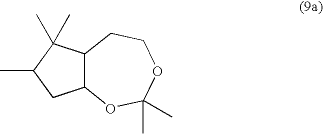

The ketal (9a) had a woody, camphoraceous, amber-like odor similar to that of compound (9), but less potent and of more sweet character.

### EXAMPLE 7

1 gram of ethyl ester (1a) was dissolved in 10 ml of absolute USP-grade ethanol and stirred on an ice bath (4-5° C.). 100 mg of sodium borohydride were introduced in small portions over period of 15 min, and the reaction mixture was allowed to gradually warm up to the room temperature while stirring was continued for additional 1 hour. The ethanol was evaporated under reduced pressure, and 5 ml of hexane was added the resulting solids. The resulting mixture was acidified to pH about 3-4 by addition of 5% sulfuric acid, while being stirred on an ice bath. The hexane layer was collected, and the remaining solution was extracted three times with 5 ml of ethyl acetate. All solvent fractions were combined, dried over anhydrous sodium sulfate, filtered and evaporated to give 780 mg of clear oil comprising mixture of about 65% hydroxyacid ester isomers (3b), 25% of hydroxyester isomers (3a) and about 6% of unreduced starting material:

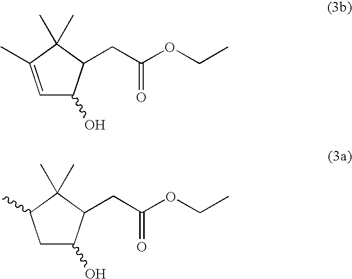

The resulting material was used without further purification for dehydration and isomerization reactions according to Example 16.

### EXAMPLE 8

1.02 g of the mixture of compounds (2a) and (2b) prepared according to Example 4A were dissolved in 4 ml of absolute USP-grade ethanol. 100 mg of sodium borohydride were introduced in small portions over 5 minutes, and the reaction mixture was stirred for 1 hour. Ethanol was evaporated under reduced pressure. 2 ml of 5% sulfuric acid were added dropwise to the solids resulting from the ethanol evaporation, and the whole was stirred on ice for 15 minutes. The resulting mixture was extracted 3 times with 5 ml of methyl tert-butyl ether, extracts were combined, dried over anhydrous sodium sulfate, filtered and evaporated under reduced pressure to give 795 mg of clear colorless oil.

The resulting crude product had a relatively faint sweet, fruity, vanilla-like, pleasant scent.GC and GC-MS analysis of the crude material showed the presence of a mixture of 4 compounds:
a) about 52% of compound having formula (4c): 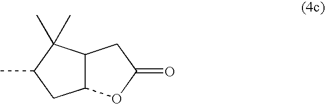
b) about 3% of compound having formula (4d): 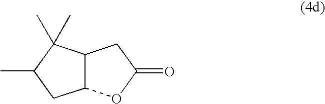
c) about 37% of an isomer of compound having formula (3c): 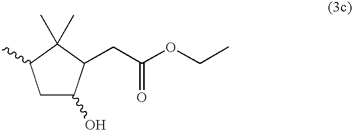
d) about 7% of unreacted starting material having formulae (2a) and (2b).

The compound (4c) had a mass-spectrum with the following characteristic ion peaks, m/z (% abundance): 168 (7, M⁺), 153 (8), 139 (2), 135 (5), 126 (9) 108 (65), 96 (13), 84 (100), 79, (7), 69 (99), 55 (20), 41 (32).

The compound (4d) had a similar mass-spectrum with the following ion peaks, m/z (% abundance): 168 (7, M⁺), 153 (8), 139 (1), 135 (3), 126 (5) 108 (37), 96 (10), 84 (100), 79, (5), 69 (86), 55 (17), 41 (24).

The compound (3c) had a mass-spectrum with the following ion peaks, m/z (% abundance): 214 (0.3, M⁺), 197 (0.5), 181 (7), 169 (4), 167 (2), 153 (2), 151 (3), 141 (28), 127 (47), 111 (100), 109 (33), 97 (19), 88 (14), 85 (13), 69 (30), 55 (12), 41 (13).

A 25 mg analytical sample of a 16:1 mixture of (4c) and (4d) free of hydroxyester (3c) and ketoesters (2a) and 2(b) was prepared by column chromatography on silica gel using a mixture of hexane:ethyl acetate 10:1 as eluent. The lactones (4c) and (4d) were found to be the main contributors to the odor of crude product obtained herein by sodium borohydride reduction of the compounds (2a) and (2b).

### EXAMPLE 9

368 mg of KCA were dissolved in a mixture of 2 ml of water, 2 ml of ethanol and 0.25 ml of 40% sodium hydroxide. The resulting solution was stirred at room temperature. 0.35 ml of 30% hydrogen peroxide were added in small portions over 30 minutes, and the reaction was stirred for additional 1 hour. After that, the reaction was acidified with 10% sulfuric acid until pH about 2-3 was reached. The whole was extracted 2 times with ethyl acetate, and the ethyl acetate extracts were combined, dried over anhydrous sodium sulfate and evaporated under reduced pressure. The resulting solids were dissolved in 15 ml of absolute USP grate ethanol, and 0.025 ml of concentrated sulfuric acid was added, and the whole was refluxed for 12 hours. 300 mg of CaCO₃ were added, and the reflux was continued for additional 1 hour. The resulting solution was filtered and evaporated under reduced pressure to yield 280 mg of yellowish oil, which had a characteristic pleasant powerful scent reminiscent of fruity-sweet caramel brandy, fenugreek. The caramel character was more pronounced and potent when samples of the crude product were dissolved in ethanol and applied to a moist blotter, apparently due to a hydrolysis reaction.

The oil was analyzed by GC and GC-MS and was found to contain about 98.5% of the compound (1a) (ethyl ester of starting material), and small amounts of three novel compounds (0.1-0.3% each) having formulae (15c), (15d) and (15e):

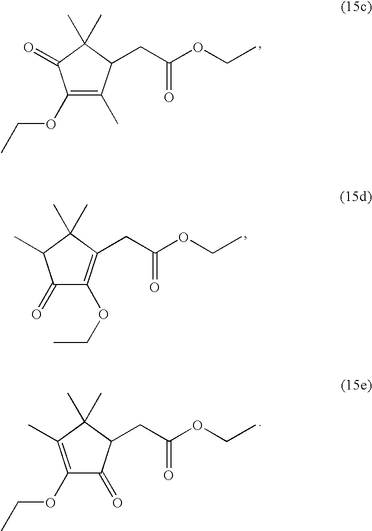

These isomeric compounds possessed similar mass-spectra with ions having m/z (% abundance) as follows:

(15c): 254 (80, M⁺), 253 (97), 239 (7), 225 (21), 207 (10), 195 (19), 179 (100), 165 (32), 151 (29), 137 (48), 123 (34), 109 (16), 95 (36), 81 (18), 69 (19), 55 (13), 43 (34);

(15d): 254 (42, M⁺), 239 (42), 225 (5), 211 (10), 195 (5), 181 (16), 179 (17), 165 (100), 151 (22), 137 (25), 123 (10), 109 (24), 95 (9), 81 (16), 67 (10), 55 (9), 43 (12);

(15e): 254 (35, M⁺), 239 (31), 225 (7), 209 (25), 208 (23), 197 (30), 193 (59), 181 (32), 179 (27), 165 (73), 151 (21), 137 (100), 123 (20), 109 (19), 95 (19), 81 (13), 69 (14), 55 (12), 43 (16).

When analyzed by GC—O, these enolone ether isomers of campholenic acids were found to have powerful and similar to each other pleasant caramel-like, brandy-like, fruity-sweet rum-like odors with some reminiscence to fenugreek.

Hydrolysis of the enol ether groups in these compounds in the presence of water led to the formation of the corresponding cyclopentenolones (15a), (15b), (15c) that have a more pronounced sweet caramel scent.

### EXAMPLE 10

409 milligrams of ketocampholenic acid were dissolved in 10 ml of 20% sodium hydroxide, and the whole was heated with stirring at 95-100° C. for 6 hours. During reaction, the solution became initially pink, and then of deep cherry color. The solution was cooled to room temperature and acidified by dropwise addition of 20% sulfuric acid. Upon acidification the solution became of a pale brandy color. The acidified solution was extracted 2 times with 10 ml of ethyl acetate, dried over anhydrous sodium sulfate and evaporated. The resulting solids were dissolved in 10 ml of absolute USP-grade ethanol, 0.025 ml of concentrated sulfuric acid was added and the whole was refluxed for 6 hours. 200 mg of CaCO₃ were added, and the solution was refluxed for additional 1 hour, cooled, filtered and evaporated under reduced pressure. The resulting brandy-colored clear oil (325 mg) had a powerful scent reminiscent of caramel brandy and fenugreek.

The oil was analyzed by GC and GC-MS and was found to contain about 2.3% of a new compound having formula (16a), with the remainder being compound (1a):

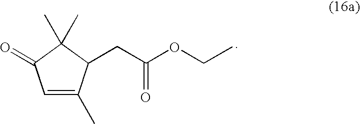

The mass-spectrum of the compound (16a) was very similar in m/z values of characteristic ions in comparison to that of the compound (1a). However, the spectrum of compound (16a) had a base peak with m/z 195, and different relative abundance of molecular and fragment ions, m/z (% abundance): 210 (68, M⁺), 195 (100), 182 (8), 167(32), 165 (7), 149 (11), 137 (85), 123 (32), 121 (21), 109 (30), 95 (25), 93 (25), 79 (12), 67 (24), 55 (9), 41 (15).

The two compounds were separated by column chromatography on silica gel using hexane: ethyl acetate 20:1 as a solvent. The column-purified compound (16a) had a powerful and pleasant sweet caramel-maple syrup odor reminiscent of the odor of cyclopentenolone, with an additional attractive fruity note. The presence of even very small amounts of compound (16a), for example in the samples containing primarily compound (1a) and only 0.2-0.5% of compound (16a), was instantly recognizable due to characteristic and much more potent scent of the latter.

### EXAMPLE 11

1.52 g of solids of the fraction B prepared in Example 5 was dissolved in 10 ml of ethanol, and 0.2 ml of concentrated sulfuric acid was added. The whole was set on reflux for 12 hours. 0.5 g of calcium carbonate was added, and the reflux was continued for additional 1 hour. The solution was evaporated under reduced pressure and 10 ml of hexane were added to the remaining solids. The whole was filtered and evaporated to give 1.16 g of pale yellow oil.

The mixture was analyzed by GC and GC-MS and was found to comprise the following compounds:
a) about 47% of compound having formula (11a):

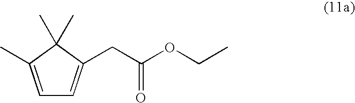

The compound (11a) had mass-spectrum comprising the following characteristic ions (m/z, % abundance): 194 (40, M⁺) 179 (0.2), 165 (1), 146 (1), 133 (1), 121 (100), 106 (32), 93 (17), 91 (32), 79 (9), 77 (8), 65 (3), 51 (2), 41 (2), 39 (2);
b) about 3% of compound having formula (10b):

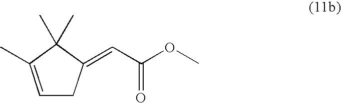

The compound (11b) had mass-spectrum comprising the following characteristic ions (m/z, % abundance): 194 (80, M⁺) 179 (20), 165 (48), 151 (21), 149 (48), 147 (8), 133 (22), 121 (100), 107 (15), 105 (60), 93 (16), 91 (34), 79 (16), 77 (19), 65 (7), 55 (4), 53 (4), 51 (4), 43 (4), 41 (7), 39 (6);
c) about 0.5% of compound having formula (10a):

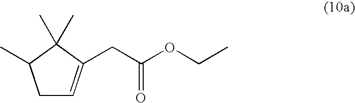

The compound (10a) had mass-spectrum comprising the following characteristic ions (m/z, % abundance): 196 (16, M⁺) 181 (5), 167 (0.2), 151 (0.5), 135 (2), 122 (3), 121 (2), 109 (100), 93 (25), 91 (10), 81 (7), 79 (8), 77 (9), 67 (12), 55 (4), 53 (3), 43 (5), 41 (4), 39 (3).
d) about 1.2% of compound having formula (10b):

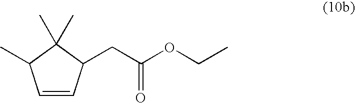

The compound (10b) had mass-spectrum having the following characteristic ions (m/z, % abundance): 196 (10, M⁺) 181 (80), 167 (0.3), 153 (2), 151 (3), 150 (2), 135 (12), 123 (14), 121 (2), 107 (100), 93 (28), 91 (14), 81 (11), 79 (9), 77 (7), 67 (6), 55 (5), 53 (4), 43 (3), 41 (6), 39 (3).

The remainder of the compound balance in the reaction product comprised about 6% of lactone (4b), about 2% of lactone (4a), about 17% of hydroxyacid esters (3a), about 13% of hydroxyacid esters (3b), and about 15% of the ethyl ester (1a).

The crude product mixture did not contain detectable amounts of any of the ethyl esters of α- or γ-campholenic acids that have different retention times and distinguishing mass-spectra compared to compounds (10a) and (10b). The crude product mixture had a powerful, pleasant, sweet, candy-like, citrus-like, fruity, mouthwatering odor that had a unique character somewhat reminiscent of odor of pure ethyl alpha-campholenate or ethyl gamma-campholenate. Analysis by GC—O indicated that the diene compounds (11a) and (11b) were main contributors to the overall odor character, and compounds (10a) and (10b), while being in relatively lower amounts, provided a distinctive, sweet, mouthwatering, fruity, sweeter note.

### EXAMPLE 12

408 mg of mixture of hydroxyester (3c) and lactones (4c), 4(d), prepared in Example 8, were dissolved in 10 ml of absolute USP grade ethanol and 0.2 ml of concentrated sulfuric acid were added. The whole was refluxed for 24 hours, 600 mg of calcium carbonate were added, and the whole was refluxed for an additional 1 hour. After removal of the solvent under reduced pressure, the solids were dissolved in 10 ml of hexane, filtered, and the hexane solution was evaporated under reduced pressue to yield 260 mg of clear oil. The oil was analyzed by GC and GC-MS and found to contain about 3% of compound having formula (10a) and about 15% of compound having formula (10b). The remainder of the mixture was compounds initially present in the starting material. The oil had a powerful mouthwatering, sweet, candy, fruit-like scent The compound (10b) was found by GC—O to be the main contributor of the characteristic odor of the mixture. The compound having formula (10a) had a pleasant fruity odor reminiscent of pure ethyl esters of α-campholenate or γ-campholenate, but somewhat sweeter, vanilla-like and more of citrus-like character.

### EXAMPLE 13

310 mg of 1,2-campholide of formula (18) of 97% purity was prepared by biological oxidation of R(+)-camphor according to a general procedure for oxidizing adamantanone described by Selifonov (1992, Biochem Biophys Res Commun,186(3):1429-36, and in references cited therein), using washed Pseudomonas putida ATCC 17453 cells grown with racemic camphor as a sole carbon source until early stationary phase, and extraction with ethyl acetate under pH about 7.2:

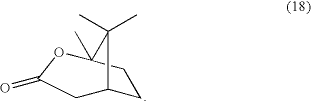

The principal impurity in the sample of campholide was 5-hydroxycampholide of formula (29):

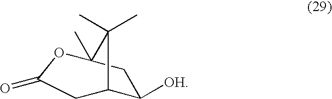

The sample of campholide (18) was saponified in 5 ml of aqueous 5% sodium hydroxide by stirring the mixture at 70° C. for 3 hours. The reaction mixture was cooled to room temperature and acidified by dropwise addition of 20% sulfuric acid until pH about 4-5 was reached. The resulting solution was extracted 3 times with 10 ml of ethyl acetate, dried over anhydrous sodium sulfate and evaporated, to give a solid comprising about 90% of 3-hydroxy-2,2,3-trimethylcyclopentylacetic acid (19) and the remainder being campholide (20). The resulting solid was dissolved in 10 ml of absolute ethanol, 0.05 ml of concentrated sulfuric acid was added, and the whole was refluxed for 6 hours. 200 mg of calcium carbonate were added, and the whole was refluxed for additional 1 hour. After filtration and evaporation of ethanol, 280 mg of clear oil was obtained. The oil had a characteristic pleasant odor very similar to that of pure α-campholenic ethyl ester

The oil was analyzed by GC and GC-MS and was found to contain about 88% of ethyl α-campholenate, about 9% of ethyl γ-campholenate and about 1% of ethyl ester of formula (11a).

### EXAMPLE 14

200 mg of 3-keto-4,5,5-trimethylcyclopentaneacetic acid of formula: 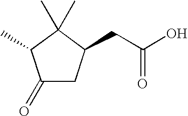
were obtained by a general method referenced in Example 13, except oxidation of R(+)camphor was conducted using washed cells of Rhodococcus sp. T1 (NCIMB 9784) grown on R(+)camphor as a sole carbon source until late exponential cells. The compound was isolated by ethyl acetate extraction of the supernatant of biological oxidation media having bacterial cells removed by centrifugation that had been acidified to a pH of about 3. The free 3-keto-4,5,5-trimethylcyclopentaneacetic acid was converted to 205 mg of the ethyl ester of formula (20a) using the esterification procedure and work-up procedure described in Example 1:

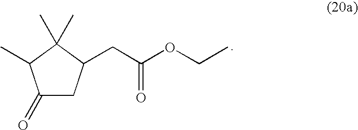

The compound (20a) was a clear yellowish oil and had a mild fruity-woody odor with a rum note.

190 mg of the ester (20a) was dissolved in 5 ml of absolute ethanol and reduced with 40 mg of sodium borohydride. The reaction after usual work up yielded 172 mg of clear colorless oil comprising about 96% of the isomers of compound having general formula (21a), with the remainder being principally the starting material (20a):

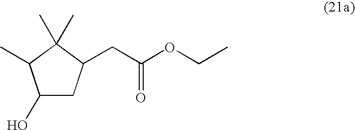

140 mg of the mixture of isomers was refluxed in 10 ml of 20% sulfuric acid for 6 hours, and the whole was extracted 3 times with 10 ml of ethyl acetate. The extracts were dissolved in 5 ml of absolute ethanol and refluxed for 3 hours in the presence of 0.005 ml of concentrated sulfuric acid. After neutralization by refluxing with 200 mg of calcium carbonate for 1 hour, the solvent was removed under reduced pressure, the solides were dissolved in 10 ml of hexane and filtered. The filtrate, upon removal of the solvent under reduced pressure, yielded 95 mg of clear yellowish oil comprising about 58% of ethyl α-campholenate and about 22% of the isomeric ethyl ester of 4,5,5-trimethylcyclopenten-2-ylacetic acid (10c), and about 17% of the unreacted isomers hydroxyester (21a):

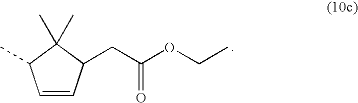

The resulting mixture had a pleasant, strong, sweet, candy-like, mouthwatering odor bearing an overall similarity to pure ethyl α-campholenate, yet having an additional characteristic sweeter fruity note.

### EXAMPLE 15

393 mg of the mixture of lactones (4a) and (4b) prepared according to Example 5 (fraction A) were dissolved in 10 ml of absolute ethanol, and 0.1 ml of concentrated sulfuric acid was added. The whole was refluxed for 14 hours, neutralized by refluxing for 1 hour with 500 mg calcium carbonate, and the solvent was removed under reduced pressure. The resulting solids were dissolved in 10 ml of hexane and filtered. The filtrate, upon removal of the solvent under reduced pressure, yielded 355 mg of a pale-yellow clear oil. with powerful very pleasant odor. GC and GC-MS analysis of the crude reaction mixture showed the presence of about 63% of compound (11a), about 16% of compound (11b), about 4% of compound (10a), about 2% of compound (10b), with the remainder being principally unreacted lactone (4a).

The product mixture had a powerful, pleasant, fruity, sweet, candy-like and somewhat citrus-like, very mouthwatering characteristic odor. The scent character was similar to that of the material obtained in Example 11.

### EXAMPLE 16

198 mg of a mixture of compound (4a) and hydroxyester (3a), prepared according to Example 7, were mixed with 1 ml of water and 2 ml of 85% phosphoric acid. The whole was heated for 24 hours at 100° C. The reaction mixture was extracted 3 times with 5 ml of ethyl acetate, dried over anhydrous sodium sulfate, evaporated and dissolved in 10 ml of absolute ethanol. 1 gram of ethanol-washed protonated form of Amberlyst 15 was added and the whole was refluxed for 12 hours. The solution was filtered and evaporated to give 117 mg of pale yellow oil that was analyzed by GC and GC-MS. The oil was found to contain about 1.5% of a cis-isomer (10b), about 22% of compound (10a), about 2% of a trans-isomer (10c), about 0.3% of compound (10d), and the principal remainder of the balance (about 74%) was represented by three stereoisomers of the saturated lactone (4a):

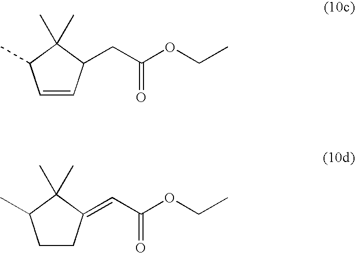

The resulting oil had a strong, mouthwatering, pleasant, fruity, vanilla-like, sweet odor with a citrus-like note. GC—O analysis revealed the compound (22%) was the principal contributor of the scent.

### EXAMPLE 17

214 mg of the mixture of lactones (4a) and (4b) prepared according to Example 5 (fraction A), 2 ml of water and 2 ml of 85% phosphoric acid were heated at 100° C. with stirring for 24 hours. During the reaction, the solution turned yellow. The resulting mixture was cooled and extracted 3 times with 5 ml 1:1 mixture of hexane and methyl tert-butyl ether, dried over anhydrous sodium sulfate and evaporated under reduced pressure to yield 1 16 mg of a greenish clear oil that had a very pleasant musk-like odor also reminiscent of a sweet candy and acetylated cedarwood oil at the same time. The oil was analyzed by GC-MS and was found to contain a complex mixture of over 50 compounds, with the principal compound series comprising isomers of compounds having molecular ions with m/z 244, 258 and 316. The compounds with molecular weight 244 were a series of methylated congeners ketones having two cyclopentenyl rings, indicative of multiple chemical reactions leading to their formation, including eliminations, isomerizations, acylations and carbon-carbon bond cleavage. The compounds with molecular weight 316 were congeners having formula (30), wherein any one of the three dashed bonds is double and two others are single:

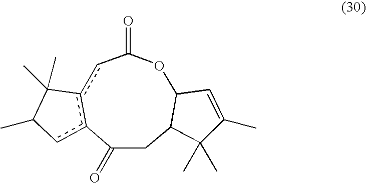

The compounds with molecular weight 258 were isomers of ketones having formula (31), wherein one of each two adjacent dashed bonds is double and another is single:

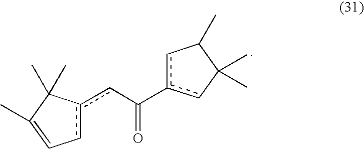

The oil obtained in this example also contained traces of compounds (11a), (11b), (10a), (10b), and about 3% of starting compounds (4a) and (4b).

### EXAMPLE 18

400 mg of an 8:1 mixture of 1,2-fencholide (21) and 2,3-fencholide (22) 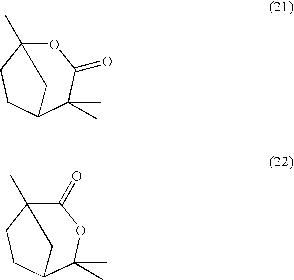
were prepared from racemic fenchone using washed cells of Rhodococcus sp. T1 (NCIMB 9784), similarly to Example 14, except that the organism was grown on fenchone as a sole carbon source. The resulting fencholide mixture had a faint characteristic odor. 300 mg of the fencholide mixture were dissolved in 10 ml of absolute ethanol and refluxed for 3 hours with 0.1 ml of concentrated sulfuric acid. The resulting solution was neutralized with calcium carbonate, filtered and evaporated under reduced pressure to yield 280 mg of clear oil. The oil had a strong characteristic odor different from the starting fencholides. The odor of the oil was reminiscent of fennel oil, pickled vegetables and had a pleasant woody-fruity note. The oil was analyzed by GC-MS and found to contain about 60% of starting fencholide and about 40% of newly formed compounds comprising compounds having formulae (23) through (28) which were found by GC—O to be responsible for the characteristic odor of the mixture. Compounds (23), (24) and (26) were principal contributors of the odor.

### EXAMPLE 19

10 grams of bakers yeast paste, 2 grams of glucose, 100 ml of water and 1 g of sodium chloride were mixed and stirred for 30 min at 30° C. 100 mg of KCA (prepared by biooxidation of natural R(+)camphor), was dissolved in 0.5 ml of ethanol and the solution was added to the mixture containing bakers yeast. The pH of the solution was adjusted to about pH 4 by dropwise addition of 5% phosphoric acid. The whole was stirred at 30° C. for two hours, 2 grams of additional glucose were added and the stirring was continued for additional 4 hours. The whole reaction mixture was extracted 3 times with 50 ml of hexanes with intensive stirring. The hexane extracts were combined, dried over anhydrous sodium sulfate, filtered and evaporated under reduced pressure to give 45 mg of clear oil that was found by GC and GC-MS to contain 85% of lactone (4b) and about 5% of lactone (4a), with the remainder being impurities comprising co-extracted lipids from the yeast.

This example demonstrates that lactones (4b) and (4a), although not yet found in nature, can be prepared in a two-step biological procedure comprising bacterial oxidation of natural camphor to ketocampholenic acid, and the reduction of the latter by the yeast.

### EXAMPLE 20

One liter of suspension of washed fresh cells of Pseudomonas putida ATCC 17453 with OD₆₀₀ about 85 in 75 mM potassium phosphate buffer pH 7.5 was prepared by growing the organism using a general growth, cell washing procedure and media, as described by Selifonov (1992, Biochem. Biophys. Res. Commun, 186(3):1429-36, and in references cited therein), except that the culture was grown in a 5-liter aerated fermentor on a mixture of glutamate (50 g/L) and racemic camphor (2 g/L) until late exponential phase of growth. The cell suspension was supplemented with 0.1 g of FeSO₄, 5 g/L of glutamate, and transferred to a 1.2 liter aerated fermentor. Solid racemic camphor (10 g) was added at once and the whole was stirred (350 rpm) and aerated (1.2 liters per minute) at 30° C. for 8 hours. The addition of another 10 g of camphor, 5 g glutamate and 0.1 g of FeSO₄ was made, and the whole was continued to be stirred at aerated for another 16 hours. During oxidation of camphor, pH of the suspension was adjusted by automatic addition of sodium hydroxide. The cells were removed by centifigation, and the pH of supernatant was adjusted by addition of sodium hydroxide to about 7.6. The supernatant was extracted 3 times with 250 ml of ethyl acetate, the extracts were combined, dried over anhydrous sodium sulfate and evaporated to give 2.3 grams of solids comprising 85% of 1,2-campholide, 3% of 5-hydroxycamphor, 2% of 2,5-diketocamphane and 6% of 5-hydroxy-1,2-campholide.

The aqueous layer was acidified by addition of hydrochloric acid until pH about 2.5 was reached, and the solution was extracted 4 times with 300 ml of ethyl acetate, which after work-up gave 14.6 grams of practically pure ketocampholenic acid.

The ketocampholenic acid had the following ¹H NMR spectrum in CDCl₃, 70 mg/ml, (δ, ppm): 1.040 (3H, s), 1.247 (3H, s), 2.037 (3H, s), 2.399 (1H, dd), 2.781 (2H, m), 5.859 (1H, s).

A number of embodiments of the invention have been described. Nevertheless, it will be understood that various modifications may be made without departing from the spirit and scope of the invention. Accordingly, other embodiments are within the scope of the following claims.

1. A compound selected from the group consisting of:
a) compounds of formula 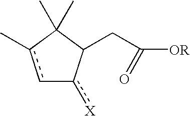
wherein R is H or a straight chain, branched, or cyclic alkyl or alkenyl group, or aralkyl group, having 1 to 10 carbon atoms, or R is a fragment of linear, branched, or cyclic alkyl or alkenyl or aralkyl polyhydric alcohol having from 2 to 6 oxygen atoms, and wherein the dashed bond in the ring is double or single,
and wherein X is OH connected to the carbon atom of the ring by a single bond, or
X is an oxygen atom connected to the ring by a double bond,
with the proviso that if R═H, at least one dashed bond is single;
b) compounds of formula: 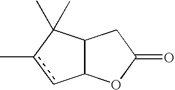
wherein the dashed bond is double or single;
c) compound of formula: 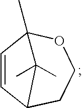
d) compounds of formula: 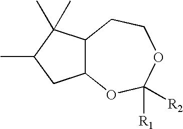
wherein R₁ and R₂ are each independently hydrogen or a straight chain, branched, or cyclic alkyl or alkenyl group, or aralkyl group, having 1 to 10 carbon atoms, or wherein R₁ and R₂ form a cycloalkane or a cycloalkene having a ring comprising from 5 to 10 carbon atoms;
e) compounds of formula: 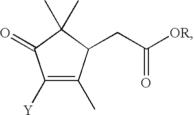
wherein Y is a hydrogen, hydroxyl, or —OR group, and R is defined as in (a);
f) compounds of formula: 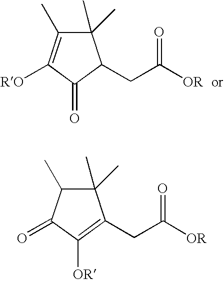
wherein R is defined in (a), and R′ is selected independently from H, straight chain, branched, or cyclic alkyl or alkenyl group, or aralkyl group, having 1 to 10 carbon atoms;
g) compound of formula: 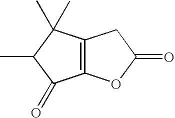
h) compounds of formula: 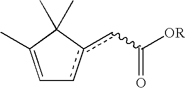
wherein R is defined in (a), and wherein any one of the dashed bonds is double and the other one is single, and wherein the wiggled bond has E or Z configuration;
i) compounds of formula: 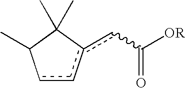
wherein R is defined in (a), and wherein any one of the dashed bonds is double and the other two are single.

2. A composition comprising a base material and an olfactorily effective amount of a compound according to claim 1.

3. A method of imparting a fragrance or flavor to a base material comprising combining the base material with an olfactorily effective amount of a compound according to claim 1.

4. A method of making a modified terpenoid compound, said method comprising:
a) providing at least one cyclic terpenoid compound, said terpenoid compound having from about 9 to about 16 carbon atoms, and at least one ring comprising from 3 to 9 carbon atoms optionally including one oxygen atom, and
b) subjecting the cyclic terpenoid compound to biological microbial oxidation thereby forming an oxidized terpenoid compound having at least one carboxyl group, carboxylate anion group, carboxylic ester group, or cyclic ester group, and
c) conducting at least one chemical reaction with the oxidized terpenoid compound prepared according to the step b), said chemical reaction being selected from esterification, trans-esterification, reduction, oxidation, elimination, isomerization, carbon-carbon bond forming reactions, carbon-carbon bond cleaving reactions, and combinations thereof,
with the proviso that
i) at least one of the steps b) or c) cleave at least one bond in the ring of cyclic terpenoid compound provided in step a), and
ii) if step b) comprises intramolecular esterification to form a lactone, then step c) comprises at least two chemical reactions.
thereby forming a modified terpenoid compound having flavor- or fragance-imparting capabilities.

5. A method of claim 4, wherein the cyclic terpenoid compound is selected from the group consisting of camphor, fenchone, fenchyl alcohol, borneol isoborneol, glycosides thereof, and esters thereof with alkanoic or alkenoic, linear, branched, or cyclic carboxylic acids, said acids having 1 to 10 carbon atoms and 1 to 3 carboxyl groups.

6. A method of claim 4, wherein the biological microbial oxidation is effected using a microorganism possessing at least one terpene hydroxylase activity or a Baeyer-Villiger type monooxygenase activity with cyclic ketones.

7. A method as claimed in claim 4, comprising:
oxidizing the cyclic terpenoid compound to form an oxidized terpenoid compound selected from the group consisting of 1,2-campholide, 5-hydroxy-1,2-campholide, 3-hydroxy-2,2,3-dimethylcyclopentanylacetic acid, and combinations thereof;
esterifying or transesterifying the oxidized compound with an alcohol to form an ester; and
dehydrating the ester to form an α-campholenic (2,2,3-trimethylcyclopent-3-enylacetic) acid ester having the formula: 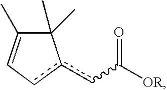
wherein R is a straight chain, branched, or cyclic lower alkyl or alkenyl group, or aralkyl group, having from 1 to 10 carbon atoms, and wherein any one dashed bond is double and the other is single, and wherein the wiggled bond is in E or Z configuration.

8. A method of claim 4 wherein the microorganism is selected from the group consisting of bacteria, yeast, and fungi.

9. A method of claim 4, wherein the compound having flavor or fragance capabilities is selected from the group consisting of esters of a trimethylcyclopentenenylacetic acid and esters of a trimethylcyclopentadienylacetic acid.

10. A method of claim 4, wherein the oxidized terpene compound is selected from the group consiting 2-keto-4,5,5-trimethyl-cyclopent-3-enylacetic acid, 3-keto-4,5,5-trimethylcyclopentylacetic acid, and salts thereof.
